(19) United States
(12) Patent Application Publication
(10) Pub. No.: US 2003/0006221 A1
(43) Pub. Date: Jan. 9, 2003

(54) Method and apparatus for cutting a multi-layer substrate by dual laser irradiation

(76) Inventors: Minghui Hong, Singapore (SG); Kaidong Ye, singapore (SG); Chengwu An, Singapore (SG); Da Ming Liu, Singapore (SG)

Correspondence Address: NIXON & VANDERHYE P.C., 8th Floor, 1100 North Glebe Rd., Arlington, VA, 22201-4714, US

(21) Appl. No.: 10/047,119

(22) Filed: Jan. 17, 2002

(30) Foreign Application Priority Data
Jul. 6, 2001 (SG) 200104057-5

(51) Int. Cl. B23K 26/38; B23K 26/067

(52) U.S. Cl. 219/121.72; 219/121.76

(57) ABSTRACT

A method and apparatus are provided for cutting a substrate using dual laser irradiation. Two lasers are provided, one focussed on a first substrate layer and one on a second layer so as to ablate the said layers. The wavelength and other parameters of the lasers are selected so as to correspond with the layer material to be ablated. The invention is particularly suitable for the singulation of IC packages.

This invention relates to a method and apparatus for cutting a substrate using dual laser irradiation. In particular, it relates to such a method and apparatus for use with an integrated circuit package. The invention has particular application in the singulation of integrated circuit components.

Silicon wafers or integrated circuit (IC) units are typically made up of a number of individual layers. These layers may comprise a printed circuit board (PCB) package upon which are provided some or all of the following; metal circuitry, dielectrics, wafer dies, bonding wires and moulding compound materials. Typically, a number of individual IC units will be formed on one package, which will be marked so as to define the boundaries of the individual IC units. It is therefore necessary to singulate the package so as to separate each individual IC unit.

A known singulation technique is that of mechanical sawing. U.S. Pat. No. 6,140,708 to Lee et al, entitled “Chip Scale Package And Method For Manufacture Thereof”, discloses a manufacturing process in which the individual units are singulated from an encapsulated package using a diamond saw. This prior technique has many drawbacks. The saw must be manufactured to exacting standards of homogeneity and flatness. Water is also required during the sawing process to clean the sawing debris and to dissipate the heat generated. Another disadvantage is that the high degree of wear requires frequent saw replacement, which leads to high equipment costs. Furthermore, the minimum cut width of the saw imposes limitations on the density of IC unit fabrication. In addition, the mechanical sawing process can lead to cracks, particularly in relation to thinner IC units. A particular problem is the use of metal substrates, which have recently gained in popularity due to their low cost. Typically, such a substrate will have a copper plate base coated with a layer of nickel. However, metal substrates generate metal debris which can lead to problems—for example, the metal is harder to cut, and metal debris has a greater tendency to stick to the saw blade, damaging both the IC units and the saw blade itself.

Another technique for the singulation of IC units is that of laser singulation. WO 01/10177 (XSIL Technology Limited) discloses a method and apparatus for singulation of IC units using a laser. The laser energy is scanned across the IC package using either rotating or laterally moveable mirrors. This method also has drawbacks. The cutting speeds attained by using this technique are quoted as 4.2 mm/sec and 8.3 mm/sec. Furthermore, the thickness of package suitable for cutting using this technique is limited by the depth of focus of the laser beam. This technique is therefore not suitable for many industrial applications.

There is therefore a requirement for an improved method and apparatus avoiding the above disadvantages. In particular, there is a requirement for a method and apparatus for cutting a substrate using laser irradiation that avoids the problems of diamond-wheel saw dicing (e.g. high cost of renewables, frequent wear, large minimum cut width, cracking, need for water to remove debris and dissipate heat) while providing fast cutting speeds and being suitable for use with thicker substrates.

It is an object of the present invention to fulfil the above requirements.

According to the above object the invention comprises a method of cutting a substrate comprising the steps of:

a) providing a laterally disposed substrate;

b) focussing a first laser beam onto a first laser focus point on the substrate;

c) focussing a second laser beam onto a second laser focus point on the substrate, the second laser focus point being relatively vertically displaced from the said first laser focus point; and

d) effecting relative lateral movement between the said substrate and the said first and second laser focus points respectively so that the said first laser focus point follows a cutting path on the said substrate, the said second laser focus point also following the said cutting path but being relatively vertically displaced from the said first laser focus point, a first layer of the said substrate being removed along the cutting path by the first laser beam and a second layer of the said substrate being removed along the cutting path by the second laser beam.

According to one embodiment, both first and second laser beams irradiate the same lateral face of the substrate.

According to a second embodiment, the first and second laser beams irradiate first and second lateral faces of the substrate respectively.

Preferably, the substrate is composed of plural layers. Further preferably, each said layer comprises different materials or combinations of materials. Still further preferably, the properties of each said respective laser beam are selected so as to be suitable for the removal of the particular layer or layers to be removed thereby. Advantageously, the first and second laser beams are independently focusable.

According to a second aspect, the invention comprises apparatus for carrying out the above method.

For a better understanding of the present invention and to show more clearly how it may be carried into effect reference will now be made, by way of example, to the accompanying drawings which show schematically various embodiments of the present invention. The figures may not be to scale.

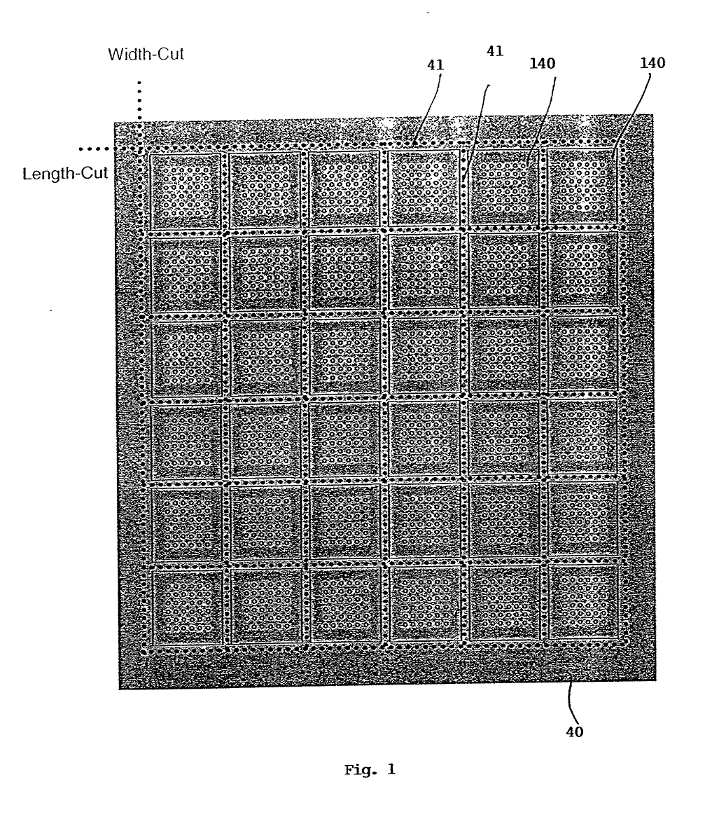

FIG. 1 shows an IC package including a number of IC units suitable for separation using the invention;

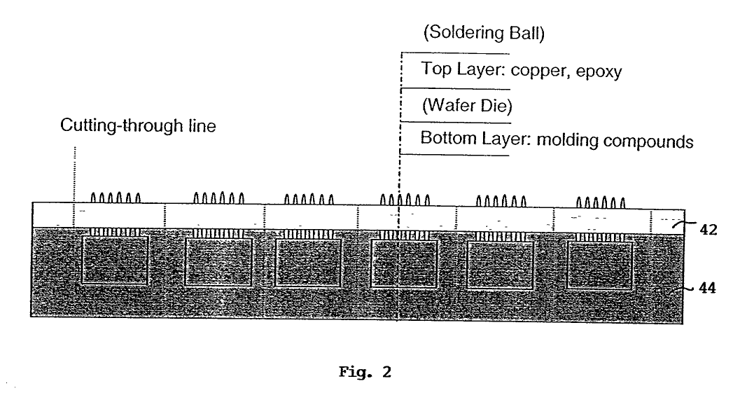

FIG. 2 is a partial cross-sectional view of the package of FIG. 1;

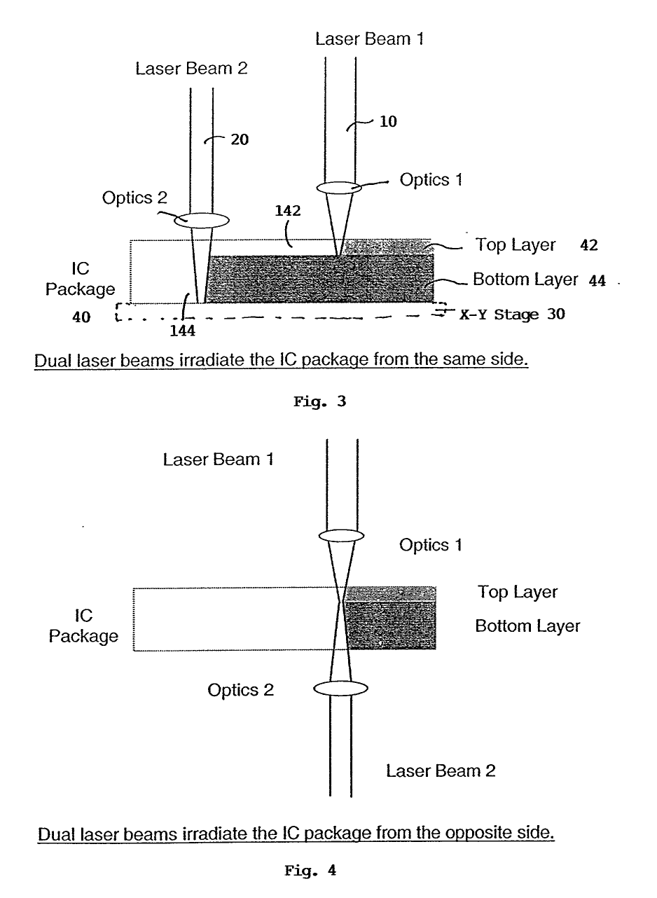

FIG. 3 illustrates a first embodiment of the invention wherein the first and second laser sources irradiate the same lateral face of the substrate;

FIG. 4 illustrates a second embodiment of the invention wherein the first and second laser sources irradiate opposite lateral faces of the substrate;

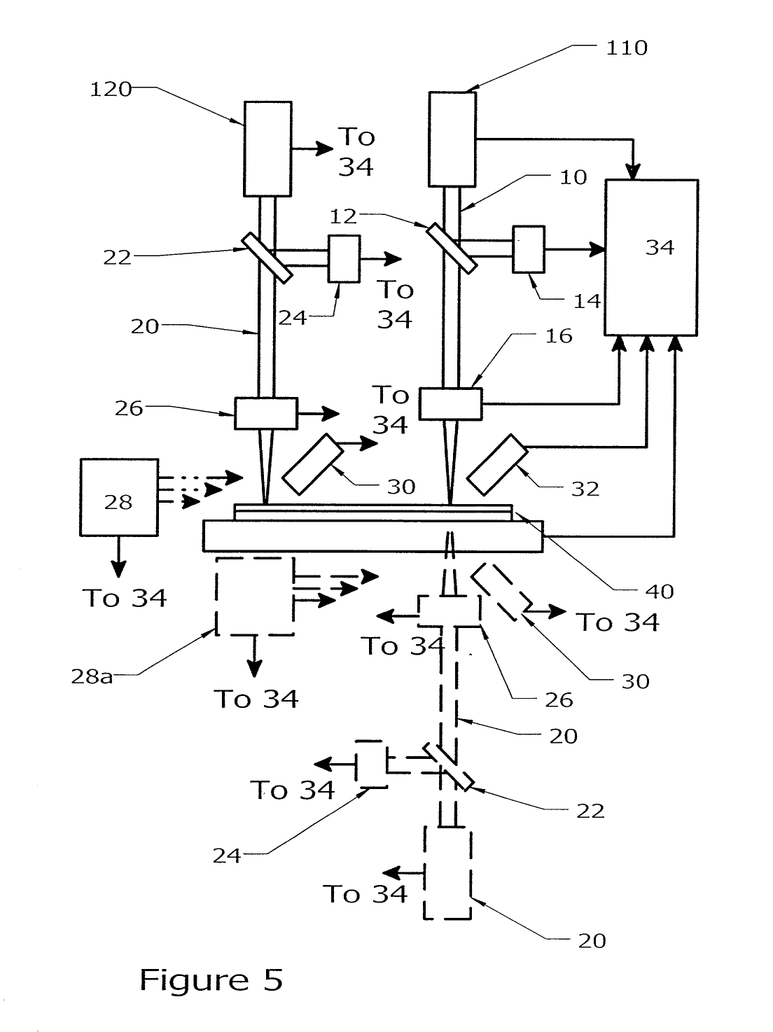

FIG. 5 shows an apparatus according to the present invention;

FIG. 6 shows a laser source scheme having different laser sources for light of different wavelengths.

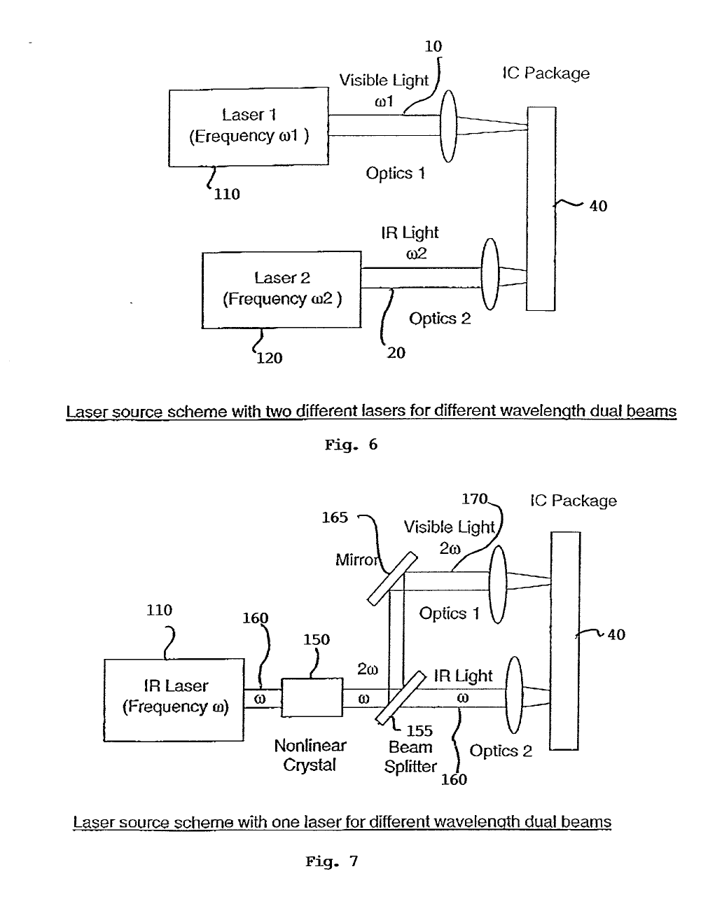

FIG. 7 shows a laser source scheme in which one laser source provides two beams of light of different wavelengths.

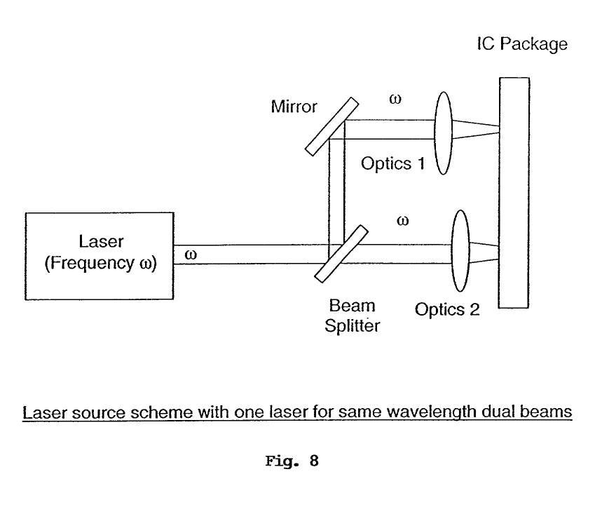

FIG. 8 shows a laser source scheme in which one laser source provides two beams of light of the same wavelength.

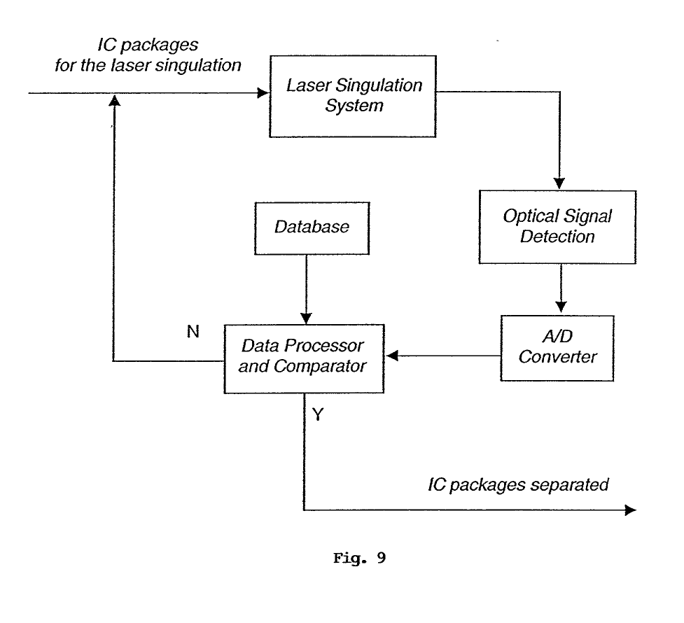

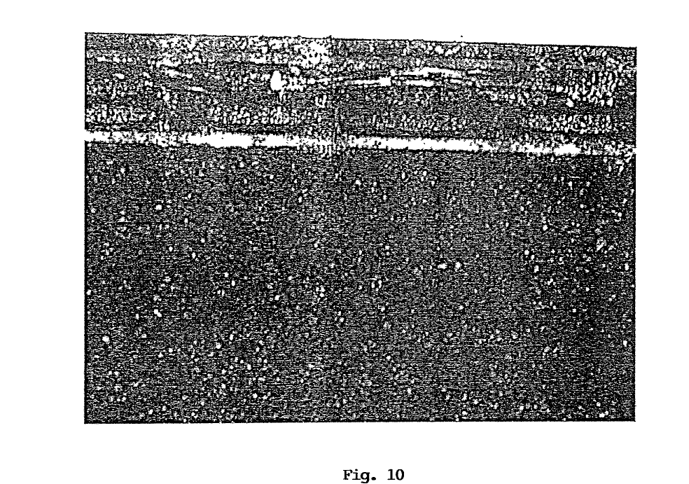

FIG. 9 is a block diagram showing the signal diagnostics and process real-time monitoring system of the apparatus according to the present invention; and

FIG. 10 is a microscopic photo showing a cross-section of an IC unit cut using the present invention.

As illustrated in FIGS. 1 and 2, an IC package 40 includes a plurality of IC units 140 Separation of the units 140 is effected by cutting along the predetermined tracks 41 The package typically comprises a first layer (42, FIG. 2), which may for example consist of copper and/or epoxy and a second layer (44) which may consist of moulding compounds.

FIG. 3 shows the cutting region of one embodiment of the invention. A first laser beam (10) and a second laser beam (20) are arranged so as to irradiate the same lateral face of an IC package (40), which is supported by an X-Y stage (30). In this particular realisation, the first laser beam (10) is generated by a 532 nm, 50W Nd:YAG laser source with a pulse repetition rate up to 50 kHz and the second laser beam (20) is generated by a 1064 nm Nd:YAG laser with a pulse duration of 7 ns The IC package (40) is fixed to the X-Y stage (30) and comprises a first layer (42) which comprises copper and/or epoxy materials and a second layer (44) which comprises moulding compounds.

In a first step, the first laser beam (10) is focussed onto a first laser focus point on the substrate, the said point being located on the first layer (42). Laser beam (20) is provided adjacent to laser beam (10) and focussed onto a second laser focus point on the substrate, the said second point being offset from the first point in the direction opposite to the direction of motion of the substrate and located on the second layer (44) The X-Y stage carries the IC package (40) moving under a predetermined speed and along said predetermined track (left to right in the figure) The first laser beam (10) scans the first layer (42) along the said track, forming a first kerf (142) through the entire thickness of the first layer (42). The second laser beam (20), laterally offset downstream of the first laser beam, scans the (now exposed) second layer (44) along the said track, forming a second kerf (144) through the entire thickness of the second layer (44). The IC package is therefore separated by the two kerfs (142, 144).

FIG. 4 shows a corresponding view of a second embodiment of the invention. In this embodiment, the second laser beam is directed towards the opposite lateral face of the package In this embodiment, the two laser focus points are vertically coincident so that the IC package is separated at the same time by the two laser beams.

FIG. 5 is a more complete view of the apparatus according to the invention. A first laser source (110) generates a first laser beam (10) which passes through a beam sampler (12) and is focussed by an optical system (16) onto a first layer (42, FIG. 3) of an IC package (40). The beam sampler (12) removes a small sample (e.g. 5%) of the beam and passes it to an energy meter (14), the output of which passes to a controller (34) which may for example be a suitably programmed computer The laser beam is monitored in real time. If there is any difference between the measured and expected parameters of the laser beam (10), the controller (34) will control the laser source (110) accordingly The optical system (16), again under the control of the controller (34) modifies the various parameters of the laser beam such as size, shape and fluence so as to focus a beam having the desired parameters onto the IC package (40). A photodetector (32) is provided which detects an optical signal from the cut region and sends a signal to the controller (34) to provide further real-time process monitoring. Air-blow means (28), also under the control of the controller (34) are also provided to remove debris and provide a cooling mechanism.

An additional laser assembly comprising a source (120) is provided downstream of the first laser source (110) along the cutting path. This assembly operates in a similar way, so that a laser beam (20) passes through a beam sampler (22) (which has an associated energy meter (24)), an optical system (26) and onto the (now-revealed) second layer of the substrate (40). The laser beam (20) cuts through the said second layer so as to completely cut the substrate (40). A photodetector (30) is also provided. It is possible to provide further laser assemblies, each cutting a particular layer. It is also possible to turn the IC package over to facilitate cutting of the second layer.

An alternative embodiment (corresponding to the arrangement of FIG. 4) is shown in dashed lines in FIG. 5. In this embodiment, the second laser assembly (120, 22, 24, 26, 30) is provided facing the opposite lateral surface of the package (40). In this case, a gap must be provided in the X-Y stage (40) so that the laser beam (20) can irradiate the package (40) Additional air-blow means (28a) are provided. A particular advantage of a system having laser sources on opposed sides of the package is that the depth of kerf encountered by the second laser beam in cutting the second layer is smaller. This facilitates cooling and debris removal.

A number of different laser sources can be used. In the apparatus shown, a laser wavelength in the visible and/or infra-red spectra is preferably used for cutting the first layer (42) of the package (40), which includes copper and/or epoxy materials.

With proper control of the processing parameters, the layers can be removed at high speed. The laser sources (110, 120) may be, for example, a 532 nm 50 W Nd:YAG laser with a pulse repetition rate up to 50 kHz, or alternatively a 1064 nm Nd:YAG laser with a pulse duration of 7 ns. One sample IC package with a 300 μm thick top layer and 800 μm thick bottom layer is cut by the abovementioned 532 nm Nd:YAG laser. The top layer was cut with 120 μm cutting width under 35 W laser power and 10 kHz pulse repetition rate The bottom layer was cut by a 1064 nm Nd:YAG laser with 120 μm cutting width at a 6 J/cm² laser fluence and pulse number of 30. The cutting speed was 125 mm/s.

In another run, a second sample IC package with a 500 μm thick top layer and 1000 μm thick bottom layer was cut. The top layer was cut by an 1064 nm Nd:YAG laser with 120 μm cutting width under a 4.5 J/cm² laser fluence and a pulse number of 70. The bottom layer was cut with a 1064 nm Nd:YAG laser with a 120 μm cutting width, a laser fluence of 6 J/cm² and a pulse number of 70. Cutting speed was 100 mm/s. With dual laser beam irradiation, the IC packages were therefore separated at speeds substantially greater than the minimum 80 mm/s required by industry.

During laser singulation, copper, epoxy and moulding compounds give rise to tiny particles of debris which are ejected from the cutting kerf. Since this debris may be redeposited on the package surfaces and contaminate the IC packages, it is preferable to provide means for debris removal. A gas stream generator (e.g. air-blow means) (28) (with alternatively or in addition a suction system, not shown) is used to remove debris. The generator is under the control of the controller (34). With proper control of the gas nozzle position, size and gas flow speed, complete removal is possible.

FIGS. 6, 7 and 8 illustrate three alternative multiple-laser-beam arrangements. In FIG. 6, two independent laser sources, having light of different wavelengths, are provided. This alternative has the advantage of a simple optical setup, although it requires precise synchronisation between the two lasers, leading to a higher equipment cost.

In FIG. 7, one single laser is used which may be for example a short pulse-duration, high pulse-energy 1064 nm Nd:YAG laser. The laser beam (160) passes through a non-linear crystal (150) which converts around 50% of the beam into a beam (170) of 532 nm laser light. A selective beam splitter (155) is then used to direct the second beam (170) to a mirror (165) and onto the IC package. The remaining portion of the first beam (160) irradiates the package as before. Although the optical system is more complicated, only one laser source is required.

In FIG. 8, a non-linear crystal is not used, a beam splitter simply being used to split up the beam into two beams having the same wavelength. This arrangement has the advantage of simplicity although it does not provide two beams of different, particularly advantageous, wavelengths. However, if the laser fluence or pulse irradiation is increased, satisfactory cutting speeds may be attained at lower cost.

FIG. 9 shows the signal diagnostics and real-time process monitoring for the apparatus according to one embodiment of the current invention. Photodetectors (30 & 32) are used to detect the optical signals generated during the laser interactions with the IC package. It is found that the optical signals disappear after these layers have been completely removed. This can be used as a feedback control mechanism to detect complete cutting of the IC package. In this system, the captured optical signals are digitized through an A/D converter (not shown) and then compared with an expected setting by the controller (34). If complete separation is detected, a new sample can be obtained for cutting. If incomplete separation is detected, further laser processing can be undergone.

FIG. 10 shows the effectiveness of laser cutting according to the invention in providing a good cutting edge. It shows a partial cross-section of the cut edge. The cut width is 120 μm. The top layer was removed using a 532 nm Nd:YAG laser at a speed of 125 mm/s with a laser power of 35W and a pulse repetition rate of 10 kHz The bottom layer was removed using a 1064 nm Nd:YAG laser with a laser fluence of 6 J/cm² and pulse number of 30. In this setup, cutting speeds of 125 mm/s were obtained, which compares well with typical industry requirements of 80 mm/s. As IC packaging technology develops, IC unit spacing will be smaller and package thickness will also reduce. This will enable laser IC singulation at even greater speeds.

1) A method of cutting a substrate comprising the steps of:
a) providing a laterally disposed substrate;
b) focussing a first laser beam onto a first laser focus point on the substrate;
c) focussing a second laser beam onto a second laser focus point on the substrate, the second laser focus point being relatively vertically displaced from the said first laser focus point; and
d) effecting relative lateral movement between the said substrate and the said first and second laser focus points respectively so that the said first laser focus point follows a cutting path on the said substrate, the said second laser focus point also following the said cutting path but being relatively vertically displaced from the said first laser focus point, a first layer of the said substrate being removed along the cutting path by the first laser beam and a second layer of the said substrate being removed along the cutting path by the second laser beam.

2) A method according to claim 1 wherein both first and second laser beams irradiate the same lateral face of the substrate.

3) A method according to claim 1 wherein the first and second laser beams irradiate first and second lateral faces of the substrate respectively.

4) A method according to any previous claim wherein the substrate is composed of plural layers.

5) A method according to claim 4 wherein further laser beams are provided, the number of laser beams corresponding to the number of separate layers to be removed.

6) A method according to claim 4 or claim 5 wherein each said layer comprises different materials or combinations of materials.

7) A method according to claim 6 wherein the properties of each said respective laser beam are selected so as to be suitable for the removal of the particular layer or layers to be removed thereby.

8) A method according to any previous claim including the additional step of optically monitoring the cutting region, the cutting process being controlled in response to the said optical monitoring.

9) Apparatus for cutting a substrate comprising:
a) means for supporting a laterally disposed substrate;
b) means for generating a first laser beam which in use is focussed onto a first laser focus point on the substrate;
c) means for generating a second laser beam which in use is focussed onto a second laser focus point on the substrate, the second laser focus point being relatively vertically displaced from the said first laser focus point; and
d) means for effecting relative lateral movement between the said substrate and the said first and second laser focus points respectively so that the said first laser focus point follows a cutting path on the said substrate, the said second laser focus point also following the said cutting path but being relatively vertically displaced from the said first laser focus point, a first layer of the said substrate being removed along the cutting path by the first laser beam and a second layer of the said substrate being removed along the cutting path by the second laser beam.

10) Apparatus according to claim 9 wherein the first and second laser beams are arranged so as to irradiate the same lateral face of the substrate.

11) Apparatus according to claim 9 wherein the first and second laser beams are arranged so as to irradiate first and second lateral faces of the substrate respectively.

12) Apparatus according to any previous claim wherein the substrate is composed of plural layers.

13) Apparatus according to claim 12 wherein further laser beams are provided, the number of laser beams corresponding to the number of separate layers to be removed.

14) Apparatus according to any of claims 9-13 wherein at least two of the said laser beams provide laser light having different parameters.

15) Apparatus according to claim 14 wherein the said parameters include one or more of wavelength, pulse duration and intensity.

16) Apparatus according to any of claims 12-15 wherein each said layer comprises different materials or combinations of materials.

17) Apparatus according to claim 16 wherein the properties of each said respective laser beam are selected so as to be suitable for the removal of the particular layer or layers to be removed thereby.

18) Apparatus according to any of claims 9-17 wherein beam splitter means are provided so that at least two laser beams are derived from the same laser source.

19) Apparatus according to any of claims 9-18 wherein optical monitoring means are provided for optically monitoring the cutting region, means being provided to control the cutting process in response to the said optical monitoring.

20) A method substantially as herein described and illustrated in the accompanying drawings.

21) Apparatus substantially as herein described and illustrated in the accompanying drawings.
